(19) United States
(12) Patent Application Publication
(10) Pub. No.: US 2009/0146790 A1
(43) Pub. Date: Jun. 11, 2009

(54) RFID tag and method and device for the production thereof

(76) Inventor: Francisco Speich, Gipf-Oberfrick (CH)

Correspondence Address: George Pappas, 919 S. Harrison Street, Suite 300, Fort Wayne, IN, 46802, US

(21) Appl. No.: 12/321,295

(22) Filed: Jan. 20, 2009

Related U.S. Application Data
(63) Continuation-in-part of application No. PCT/CH2007/000251, filed on May 16, 2007.

(30) Foreign Application Priority Data
Jul. 24, 2006 (CH) CH 1194/06

(51) Int. Cl. H04Q 5/22

(52) U.S. Cl. 340/10.1

(57) ABSTRACT

Disclosed is an RFID tag comprising a textile design tag (4), on the rear face (6) of which a transponder is arranged that is provided with a chip (14) comprising an antenna (12). In order to create a simplified and thinner RFID tag, the antenna (12) is incorporated into or is applied to a support layer (10) and is connected to the chip (14) in the form of a transponder tag (8) which is connected directly to the design tag (4).

This application is a continuation-in-part of PCT/CH2007/00025 1 filed on May 16, 2007 designating the U.S. and claiming priority from CH 1194/06 filed on Jul. 24, 2006, the disclosures of which are incorporated herein by reference.

### TECHNICAL FIELD

The invention relates to an RFID tag and a method and a corresponding device for the production of the RFID tag.

### BACKGROUND OF THE INVENTION

WO02093524 A has disclosed an RFID tag in which a complete transponder comprising an antenna arranged on a carrier and having a connected chip is first transferred to a carrier layer, which is then connected to a design tag, the latter reaching over the carrier layer in the manner of a hem. Since the transponder is present as a unit, it forms its own layer and thus leads to a three-layer and therefore relatively thick and rigid RFID tag. Such RFID tags are relatively complicated and not very flexible and, when used in items of clothing, form undesired discontinuities, which impair the wearing comfort.

WO9429503 discloses a further RFID tag in which the design tag comprises two layers which form pockets, into which transponders are inserted. This multi-layer RFID tag is not only difficult to produce but also relatively thick and rigid and thus exhibits the same undesired properties as the RFID tag described above.

### SUMMARY OF THE INVENTION

The object of the invention is to improve an RFID tag of the type mentioned at the beginning and to specify a method and a device for the production thereof.

According to a first aspect of the invention, the object is achieved by:

A RFID tag having a textile design tag, on the rear side of which textile design tag there is arranged a transponder. The transponder has a chip provided with an antenna. The said antenna is incorporated into a textile carrier layer or applied to a textile carrier layer and is connected to the chip in the form of a transponder tag. The transponder tag is connected directly to said design tag.

The fact that the antenna is incorporated into or applied to the carrier layer means that the chip is also arranged directly on the carrier layer and connected to the antenna and thus forms a transponder tag which is connected directly to the design tag. There is thus an RFID tag that has only two layers, which is much thinner and shows much less than the known three-layer RFID tags. This improves the flexibility of the RFID tag and therefore its handling and wearing comfort.

It is particularly advantageous if the antenna is arranged in the form of a meander or zigzag, which means in particular that knitting or weaving the antenna into a knitted or woven carrier layer is possible. If appropriate, such an antenna can however also be printed or vapor-deposited onto a carrier layer. The antenna can be arranged in the manner of a coil. Preference is given to the formation of the transponder with an RFID chip. If appropriate, the RFID tag can also contain a transponder which has an HF or UHF chip. The configuration of an RFID tag is particularly advantageous, the carrier layer being knitted or woven, so that the antenna can be knitted in or woven in.

The transponder tag can contain a hot-melt adhesive thread, by means of which it is connected to the design tag. The transponder tag and the design tag can be adhesively bonded to each other, at least around the chip, or can be welded. A particularly permanent and stable RFID tag results if the transponder tag is laminated onto the design tag. On the side facing away from the design tag, the transponder tag can be provided with word and/or image symbols.

According to a second aspect of the invention in a method for the production of the RFID tags, the design tag being fed as a design tag strip and the transponder tag being fed as a transponder tag strip to a connecting station. Before the connection, a transponder tag is separated from the transponder tag strip, its length corresponding at most to the length of the RFID tag to be produced. The section is then connected to the design tag strip, at least in the region of the leading edge. The RFID tag prepared in this way is then cut off to the desired length of the RFID tag at a cutting station.

A particularly simple method results if the transponder tag strip or the transponder tag is fed to the connecting station at an angle α with respect to the design tag strip and is connected to the design tag strip in the region of the leading edge of the transponder tag.

If a section to be connected to the design tag strip is separated from the transponder tag strip and is applied to the design tag strip and connected by means of a heated press plunger, such a connection can be made at least on two mutually opposite sides or else on all sides. The transponder tag can be connected to the design tag strip by means of adhesive bonding. Such a connection can also be made by fusing, for example by means of ultrasonics or lasers.

According to a third aspect of the invention, a device for implementing the method being distinguished by:
a first feeder for a design tag strip,
a second feeder for a transponder tag strip, having a first separating station for separating a transponder tag,
a connecting station for connecting the transponder tag to the design tag strip,
a second separating station for separating the RFID tag.

The device can have means for repeat monitoring, which then serve to control the device. There can also be monitoring means for the transponder, which check the serviceability of the transponder.

Particularly expedient is the refinement according to which there are means for ejecting defective RFID tags on the second separating device. In this case the ejection means can have a nozzle device arranged under the separating station, which produces an air stream directed laterally outward, which separates out a defective RFID tag directly laterally following separation. The device can have welding means at the connecting station in order to connect the strip sections. The first feeder and the second feeder are constructed in such a way that the strips meet each other at an angle α at the connecting station, the latter having a press plunger for pressing together the parts of the strip lying one above the other. The press plunger and/or a base support at the connecting station can be equipped with heating means in order to effect the welding or adhesive bonding. Also particularly advantageous is a refinement of the device according to which there is at the connecting station a press plunger which has a hollow space to accommodate at least one chip and also edge sections bounding the hollow space on at least two mutually opposite sides, which are used to connect the transponder tag to the design tag section. Expediently the device is equipped at the second separating station with a stacking device to accommodate the RFID tags produced.

The aforementioned elements and also those claimed and described in the following exemplary embodiments and to be used according to the invention are not subject to any specific exceptional conditions in terms of their size, shape, use of materials and their technical conception, so that they can be applied in the respective area of application unrestricted by any selection criteria.

### BRIEF DESCRIPTION OF THE DRAWINGS

Further details, advantages and features of the subject of the present invention emerge from the following description of the associated drawings, in which:

FIG. 1 shows a first RFID tag with design tag and transponder tag with a meander-like antenna in plan view;

FIG. 2 shows the RFID tag from FIG. 1 in the section I-I from FIG. 1;

FIG. 3 shows a transponder tag having a coil-like antenna in plan view;

FIG. 4 shows the transponder tag from FIG. 3 in the section III-III from FIG. 3;

FIG. 5 shows a device for the production of an RFID tag in a schematic, partly sectioned side view;

FIG. 6 shows the device according to FIG. 5 during the connection of the transponder tag to the design tag; and

FIG. 7 shows a further device for the production of an RFID tag.

### DETAILED DESCRIPTION OF THE PREFERRED EMBODIMENT

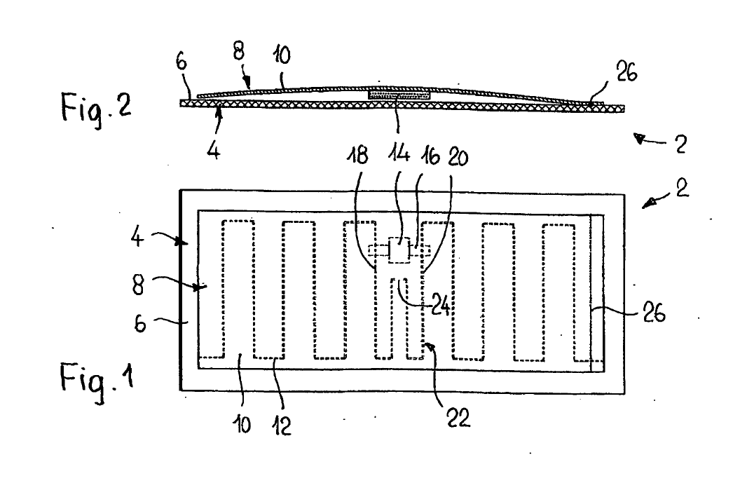

FIGS. 1 and 2 show an RFID tag 2 which has a design tag 4, on the rear side 6 of which there is arranged a transponder tag 8. This transponder tag 8 has a carrier layer 10, in which an antenna 12 is arranged in the form of a meander. A chip 14 has lugs 16, by means of which the chip is connected to antenna sections 18, 20. The antenna sections 18, 20 are provided on a short-circuit bridge 22 having an interruption 24. The transponder tag 8 is somewhat shorter than the design tag 4 and, for example, is adhesively bonded or welded to the design tag at a connecting point 26 in the region of the leading edge of the transponder tag.

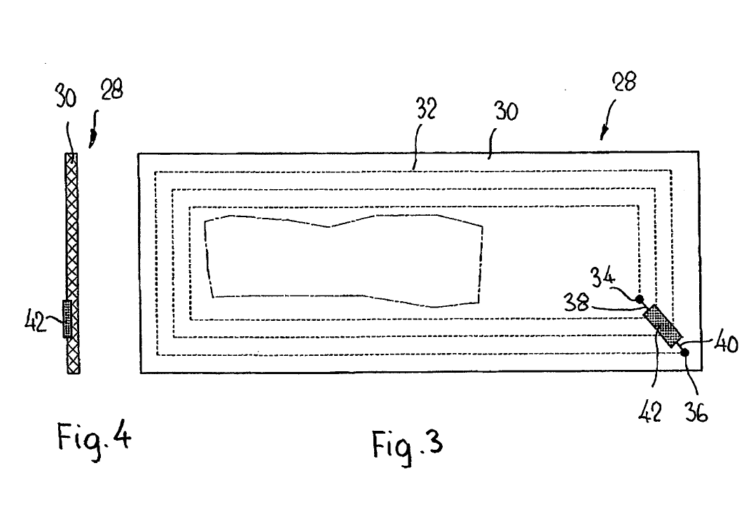

FIGS. 3 and 4 show a further transponder tag 28, which has a carrier layer 30 on which an antenna 32 is arranged in the manner of a coil, the ends 34, 36 of which are connected to terminals 38, 40 of a chip 42. Such a transponder tag 28 can also be connected to a design tag of the type described in FIGS. 1 and 2.

The transponder tags shown in FIGS. 1 to 4 have a carrier layer made of a textile two-dimensional structure, which is preferably woven or knitted. The antenna is advantageously incorporated in the two-dimensional structure in the course of the production of the latter, which means it is woven in or knitted in, which is preferred in particular in the embodiment according to FIGS. 1 and 2. If appropriate, the antenna can also be applied after the production of the two-dimensional structure, for example by sticking on or pressing on, which is the case in particular in the case of the transponder tag according to FIGS. 3 and 4.

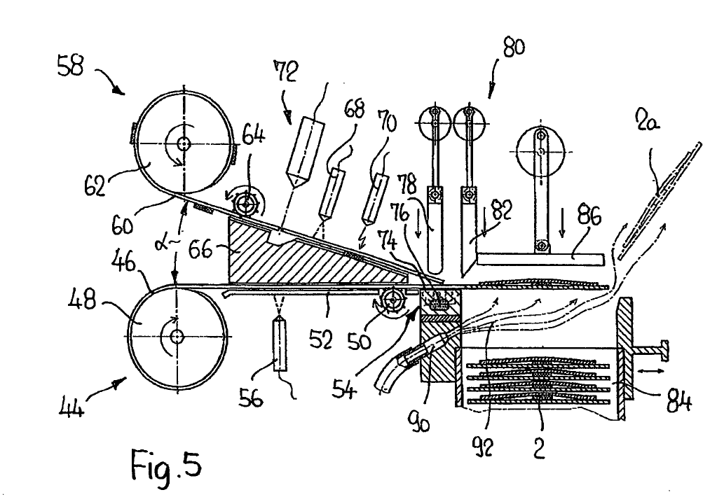

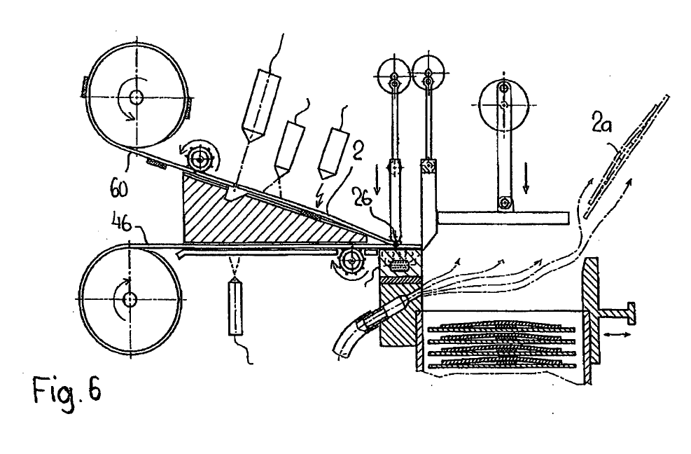

FIGS. 5 and 6 show a device and a method for the production of an RFID tag 2 according to FIGS. 1 and 2. The device contains a first feeder 44, in which a design tag strip 46 from a supply roll 48 is fed by means of a transport wheel 50 over a support 52 to a connecting station 54. The first feeder 44 is further equipped with a repeat sensor 56, which he responds to marks on the design tag strip 46 in order to determine the feed length of the design tag strip 46 to the connecting station 54.

The device contains a second feeder 58 for a transponder tag strip 60, which is drawn off a supply roll 62 by means of a transport wheel 64 and is likewise fed longitudinally to a support 66 of the connecting station 54. The support 66 is inclined at an angle a with respect to the support 52 of the first feeder 44, so that the transponder tag strip 60 is fed to the connecting station 54 in the desired position. The second feeder 58 likewise contains a repeat sensor 68, which responds to marks on the transponder tag strip 60 and controls the feed length. Furthermore, there is a transponder monitor 70, which checks the transponder tags for serviceability. Furthermore, the second feeder 58 is equipped with a second separating station 52, which separates a transponder tag 8 from the transponder tag strip 60 at the desired length.

The connecting station 54 contains a base support 54 having a heater 76 and a press plunger 78 which can be fed in and which can likewise be fitted with a heater, not specifically illustrated. The press plunger presses the transponder tag 8 in the region of its leading edge against the design tag strip 46 and forms the connecting point 26, for example by a hot melt adhesive in one of the two layers being activated by the heating device 76. Arranged downstream of the connecting station 54 is a second separating station 80 which, for example, uses a separating knife 82 moving up and down to separate RFID tags 2 from the design tag strip 46 at the desired length, these being deposited in a stacking device 84. A press plate 86 moving up and down assists the stacking operation.

The device is also equipped with ejection means, arranged downstream of the second separating station 80, for ejecting defective RFID tags 2a. The ejection means contain a nozzle device 90 which is arranged under the second separating station 80 and which generates an air stream 92 directed laterally outward, if, for example, the transponder monitor 70 indicates a faulty tag 2a. The latter is then blown out laterally before being deposited in the stacking device 84.

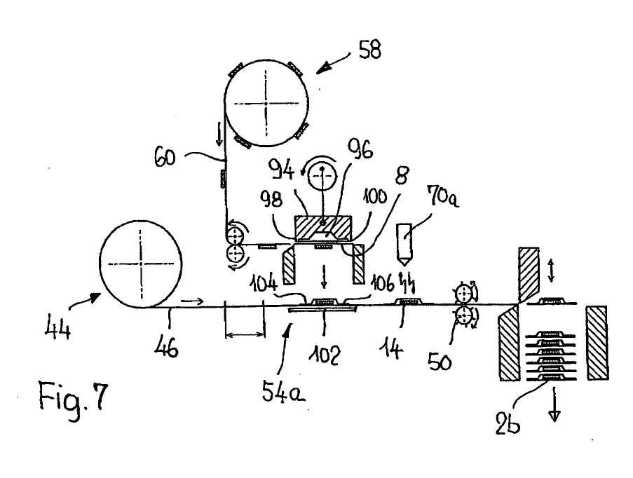

FIG. 7 shows a further device for the production of RFID tags 2b from a design tag 4 and a transponder tag 8, which is constructed in a similar way to the device of FIGS. 5 and 6, meaning that identical parts are provided with identical designations. By means of transport wheels 50, the first feeder 44 transports the design tag strip 46 first to a connecting station 54a and then onward along a transponder monitor 70a to a second separating station 80, in which finished RFID tags 2b are separated by means of the separating knife 82 and fed to the stacking device 84. The second feeder 58 conveys the transponder tag strip 60 to the connecting station 54a. In this exemplary embodiment, the connecting station 54a is equipped with a press plunger 94 which has a hollow space 96 to accommodate at least one chip 14. The hollow space 96 is bounded on at least two mutually opposite sides by edge sections 98 and 100, which on the one hand are used to separate a transponder tag 8 from the transponder tag strip 60 and on the other hand to connect the transponder tag 8 to the design tag strip 46. For this purpose, the press plunger 94 and/or the base support 102 are provided with a heating device, not shown in more detail, in order to activate fusible parts of the design tag strip 46 and/or the transponder tag 8 and to form the connecting points 104, 106.

In a way analogous to FIGS. 5 and 6, the second device of FIG. 7 can be equipped with corresponding repeat sensors in order to control the device. In addition, there can be ejection means for ejecting damaged RFID tags, in a way analogous to the exemplary embodiment of FIGS. 5 and 6.

### List of Designations

2 RFID tag
2a RFID tag
2b RFID tag
4 Design tag
6 Rear side
8 Transponder tag
10 Carrier layer
12 Antenna
14 Chip
16 Lug
18 Antenna section
20 Antenna section
22 Short-circuit bridge
24 Interruption
26 Connecting point
28 Transponder tag
30 Carrier layer
32 Antenna
34 End of 32
36 End of 32
38 Terminal
40 Terminal
42 Chip
44 First feeder
46 Design tag strip
48 Supply roll
50 Transport wheel
52 Support
54 Connecting station
54a Connecting station
56 Repeat sensor
58 Second feeder
60 Transponder tag strip
62 Supply roll
64 Transport wheel
66 Support
68 Repeat sensor
70 Transponder monitor
70a Transponder monitor
72 First separating station
74 Base support
76 Heater
78 Press plunger
80 Second separating station
82 Separating knife
84 Stacking device
86 Press plate
90 Nozzle device
92 Air stream
94 Press plunger
96 Hollow space
98 Edge section
100 Edge section
102 Base support
104 Connecting point
106 Connecting point

1. An RFID tag having a textile design tag, on the rear side of which textile design tag there is arranged a transponder, which transponder has a chip provided with an antenna, wherein said antenna is incorporated into a textile carrier layer or applied to a textile carrier layer and is connected to said chip in the form of a transponder tag, which transponder tag is connected directly to said design tag.

2. The RFID tag as claimed in claim 1, wherein said antenna is arranged in the form of a meander or zigzag.

3. The RFID tag as claimed in claim 1, wherein said antenna is arranged in the manner of a coil.

4. The RFID tag as claimed in claim 1, wherein said transponder has an RFID chip.

5. The RFID tag as claimed in claim 1, wherein said transponder has one of an HF or UHF chip.

6. The RFID tag as claimed in claim 1, wherein said carrier layer is knitted or woven, and wherein said antenna being knitted in or woven in.

7. The RFID tag as claimed in claim 1, wherein said transponder tag contains a hot-melt adhesive thread, by means of which it is connected to said design tag.

8. The RFID tag as claimed in claim 1, wherein said transponder tag and said design tag are adhesively bonded to each other, at least around said chip.

9. The RFID tag as claimed in claim 1, wherein said transponder tag and said design tag are welded to each other, at least around said chip.

10. The RFID tag as claimed in claim 1, wherein said transponder tag is laminated onto said design tag.

11. The RFID tag as claimed in claim 1, wherein said RFID tag having two sides, a side facing to said design tag and a side facing away from said design tag, and wherein on the side facing away from said design tag, said transponder tag is provided with word and/or image symbols.

12. A method for the production of said RFID tag of claim 1, wherein said design tag is fed as a design tag strip and said transponder tag is fed as a transponder tag strip to a connecting station, a transponder tag being separated from said transponder tag strip, its length corresponding at most to the length of said RFID tag to be produced, and said transponder tag then being connected to the design tag strip, at least in the region of its leading edge, and said RFID tag prepared in this way then being cut off at the desired length of said RFID tag at a separating station.

13. The method as claimed in claim 12, wherein said transponder tag strip is fed to said connecting station at an angle (α) with respect to said design tag strip and is connected to said design tag strip in the region of the leading edge of said transponder tag.

14. The method as claimed in claim 12, wherein a transponder tag to be connected to the design tag strip is separated from said transponder tag strip and is applied to said design tag strip and, by means of a heated press plunger, is connected to said design tag strip at least on two mutually opposite sides.

15. The method as claimed in claim 12, wherein said transponder tag is connected to said design tag by means of adhesive bonding.

16. The method as claimed in claim 12, wherein said transponder tag is connected to said design tag by fusing, preferably by means of ultrasonics or lasers.

17. A device for implementing the method of claim 12, comprising:
a first feeder for a design tag strip,
a second feeder for a transponder tag strip, having a first separating station for separating a transponder tag,
a connecting station for connecting said transponder tag to said design tag strip,
a second separating station for separating said RFID tag.

18. The device as claimed in claim 17, comprising means for repeat monitoring.

19. The device as claimed in claim 18, comprising monitoring means for the transponder.

20. The device as claimed in claim 17, wherein the second separating station is assigned ejecting means for ejecting defective RFID tags.

21. The device as claimed in claim 20, wherein said ejection means have a nozzle device arranged under said second separating station, to produce an air stream directed laterally outward.

22. The device as claimed in claim 17, comprising welding means at the connecting station in order to connect said transponder tag to said design tag.

23. The device as claimed in claim 17, wherein said first feeder and said second feeder are constructed in such a way that said strips meet each other at an angle (α) at said connecting station, the latter comprising a press plunger for pressing together the parts of the strip lying one above the other, said press plunger and/or a base support at said connecting station being provided with heating means.

24. The device as claimed in claim 17, comprising at said connecting station a press plunger which has a hollow space to accommodate at least one chip and also edge sections bounding said hollow space on at least two mutually opposite sides.

25. The device as claimed in claim 17, wherein said second separating station is assigned a stacking device to accommodate said RFID tag.
